(19) United States
(12) Patent Application Publication
(10) Pub. No.: US 2009/0150238 A1
(43) Pub. Date: Jun. 11, 2009

(54) SYSTEM AND METHOD FOR THE REVERSIBLE LEASING OF ANONYMOUS USER DATA IN EXCHANGE FOR PERSONALIZED CONTENT INCLUDING TARGETED ADVERTISEMENTS

(76) Inventors: Adam Marsh, Berkeley, CA (US); Bowen Dwelle, San Francisco, CA (US)

Correspondence Address: SAWYER LAW GROUP LLP, 2465 E. Bayshore Road, Suite No. 406, PALO ALTO, CA, 94303, US

(21) Appl. No.: 12/090,236

(22) PCT Filed: Oct. 11, 2006
(86) PCT No.: PCT/US06/39743

§ 371 Date: Dec. 12, 2008

Related U.S. Application Data
(60) Provisional application No. 60/726,493, filed on Oct. 12, 2005.

(51) Int. Cl. G06Q 30/00; G06Q 90/00

(52) U.S. Cl. 705/14; 705/1

(57) ABSTRACT

A system and method for the reversible leasing of anonymous user data in exchange for personalized content including targeted advertisements includes: (a) helping users gather and manage data representing their interests (404); (b) distilling this data to a condensed and anonymous form (434); (c) making it easy to review, edit, and add to this data; (d) providing a simple way for sites to ask for this data (414); (e) enabling users to grant reversible access to a site with one click (432); (f) providing sites with multiple ways to access and use this data once the user has granted access (424) and (g) motivating the user to keep their data accurate and up-to-date (403). In this manner, Internet users can lease data to web sites in a way that is convenient, secure, and under user control, respecting the user desire for transparency and privacy, and avoiding the complexity and trust issues experienced by both users and web sites when utilizing identity management systems.

### FIELD OF THE INVENTION

The present invention relates generally to computers, software, advertising and Internet services and more specifically to a system and method of allowing Internet users to transfer anonymous user data to publishers in a simple, reversible way, and in return to receive premium or personalized content including targeted advertisements.

### BACKGROUND OF THE INVENTION

Online publishers (web sites) desire information about users (viewers of web sites) for various reasons. Some of the most important reasons are the personalization of content and the targeting of accompanying advertisements. Users are therefore frequently asked to provide such information, usually by filling out a registration form. As is known in the art, filling out this form typically results in an email being sent to the user containing a hyperlink; the user must then click on this hyperlink to validate the registration, and from that point forward remember a username and password in order to be recognized at that site.

FIG. 1 illustrates how this process works. The user 102 supplies the site 104 with personal data 110 in return for privileges, services, or personalization 108. This data is typically supplied using the above outlined registration process, and the data 114 is then stored by the site for use in personalization of content, services, or advertising. In the case of advertising, the data 114 is used to generate targeting data 118, which is then used by an ad server 106 to select targeted ads 116 that are placed on the web page in an ad space 112 for viewing by the user. Targeting data 118 may be obtained from user data 114 using services supplied by either the site 104 or a third party. The ad server 106 may also be operated by either the site 104 or a third party.

Users, however, are reluctant to fill out registration forms for various reasons. Some of the most important reasons are the inconvenience of completing the form and privacy concerns about the distribution of user information among many sites with no record or control over this distribution. Another is the combination of anonymous information with personally identifiable information.

As is known in the art, online publishers see a significant increase in the revenue they can gain from their ad space when advertisements are targeted, or matched, to user interests. However, if providing user information is required to access content, for example by requiring site registration, the number of users viewing this content is significantly reduced, even if overall advertising revenue increases. Thus as an increasing percentage of readers view content online, instead of for example buy buying printed publications, publishers are faced with either low readership or low advertising revenues.

### Shared Registration

Some publishers or third party service providers have set up shared registration systems, whereby the user registers once and gains access to several sites at once. Outsourced registration is also offered by “co-registration” ad networks, which display opt-in ads based upon user data at the time of registration or login.

However, any broadly encompassing shared registration system faces several obstacles, including the publisher desire to “own” data provided by users at their site; for example, a leading newspaper site would not find it equitable to have a small weblog enjoy equal benefits from shared registration if it felt that most readers were registering on their site. Another obstacle is a user's lack of motivation to provide accurate data, especially considering that false data completely nullifies its value. This can be seen for example in the popularity of the site bugmenot.com, which automatically provides fake username/password data for many popular sites requiring registration.

### Behavioral Targeting

Behavioral targeting has recently gained popularity as an accepted component of online advertising, evolving to include: targeting ads on a site based on segments derived from user behavior within that site; targeting ads across a network of sites based on common segments derived from user behavior at each site; and targeting ads across an ad network based on segments derived from user behavior at key sites, with these key sites gaining a part of the resulting revenue. In order to use behavioral targeting data to match ads to users, users are grouped into “audience segments,” which can then be used to sell ad inventory in the same way that content categories are used to sell contextually targeted ad inventory.

However, behavioral data obtained and used within one site or group of sites has limited usefulness, and using behavioral data from one site to target ads across an ad network raises concerns for both publishers and users. Ad revenue must be split between the site that sold the ad, the site where it appears, the site(s) who contributed to the behavioral data, and the behavioral targeting technology provider; it is a challenge to accomplish this in a way that all parties feel is equitable. Users also are increasingly uncomfortable with information obtained from their activity at one site being used to target ads at other sites that the user sees as unrelated (tracking).

### Single Sign-On and Identity Management Systems

A single sign-on (SSO) system allows a user to automatically supply an authenticated digital identity to various sites, with this identity managed at a single point. The main purpose of an SSO system is to prove to the site that the user is the person associated with this centrally managed identity; some SSO systems also allow additional personal data to be transferred after authentication as an optional feature. SSO has traditionally been a part of the much larger area of identity management systems, which typically offer a wide range of available functionalities for users and corporate administrators, including: central provisioning/deprovisioning of accounts; policy-based access control; directory services; and the establishment of “trust” between entities, who then may share data more freely. In general, identity management systems move beyond proving that a user is the same person who previously visited, with functionalities that include: proving that the user is the same person who opened an account with a third party (for example a credit card company or the government); proving that the user has authorization to access specified resources; establishing a measure of trust to be afforded the user based upon third party evaluations; and measuring resources consumed by the user during access (for example for authorization control, billing, or usage analysis).

However, SSO and identity management systems are quite complex, with both the identity management provider and participating web sites required to implement sophisticated technology and adhere to strict procedures to prevent unauthorized access by malicious intruders seeking to crack the system. In addition, most such systems are designed to manage personally identifiable information, which then requires users to place great trust in the identity management provider, who is both a repository of sensitive data and a guardian of that data against unauthorized entities.

Accordingly, what is desired is to provide a system and method which overcomes the above-identified issues. The present invention addresses such a need.

### SUMMARY OF THE INVENTION

A system and method for the reversible leasing of anonymous user data in exchange for personalized content including targeted advertisements includes: (a) helping users gather and manage data representing their interests; (b) distilling this data to a condensed and anonymous form; (c) making it easy to review, edit, and add to this data; (d) providing a simple way for sites to ask for this data; (e) enabling users to grant reversible access to a site with one click; (f) providing sites with multiple ways to access and use this data once the user has granted access; and (g) motivating the user to keep their data accurate and up-to-date. In this manner, Internet users can lease data to web sites in a way that is convenient, secure, and under user control, respecting the user desire for transparency and privacy, and avoiding the complexity and trust issues experienced by both users and web sites when utilizing identity management systems.

### BRIEF DESCRIPTION OF THE DRAWINGS

FIG. 1 illustrates the typical way in which personal data is used to personalize a site, including by targeting ads.

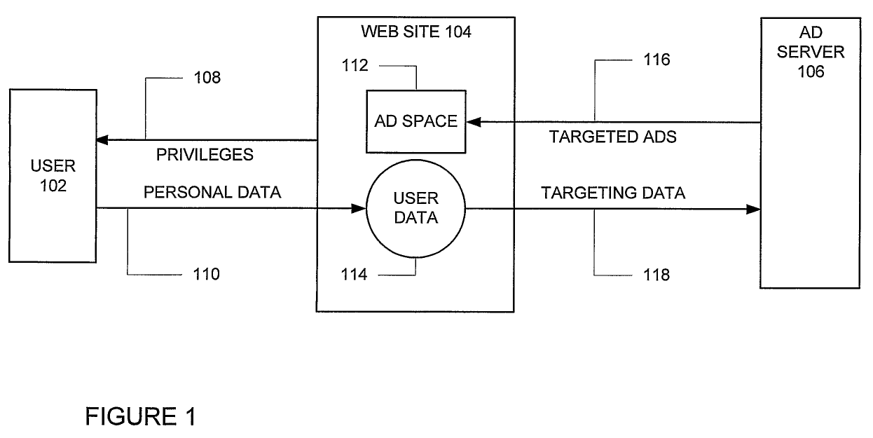

FIG. 2 illustrates how the current invention improves upon this system in one embodiment, enabling the user to grant access to anonymized data with one click.

FIG. 3 illustrates how, in one embodiment of the invention, data can be gathered, processed, edited, and allocated.

FIG. 4 illustrates the service in a typical interaction with user and publisher in one embodiment of the invention.

FIG. 5 illustrates how the site can be provided with demographics and calculated segment weights in one embodiment of the invention.

FIG. 6 illustrates the formula used to calculate segment weights in one embodiment of the invention.

### DETAILED DESCRIPTION

The present invention relates generally to computers, software, advertising and Internet services and more specifically to a system and method of allowing Internet users to transfer anonymous user data to publishers in a simple, reversible way, and in return to receive premium or personalized content including targeted advertisements. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention has the objective of providing a better method for asking users for data in return for content, in particular a method that is equitable for publishers, that accommodates user needs for privacy and control, and that motivates users to provide accurate and up-to-date information by being applicable to more than targeted advertising.

This invention targets ads based upon user-declared and user-controlled data, rather than data derived by tracking users' activities without their knowledge or involvement. The objective is to provide the publisher with rich and accurate targeting data while respecting user desires for control, transparency, and privacy.

The present invention has the objective of allowing users to provide anonymous data to web sites, which includes the necessity of proving that the user is the same person who previously offered this data. However, this proof can be accomplished in a straightforward way with little complexity, since: the data is anonymous, and therefore of little value if intercepted; the main purpose of providing the data is to access content that is of little value if accessed without proper authority; and the user has little motivation to provide false data or falsely claim to be associated with a different account, since such accounts are freely available and already under complete user control.

The objective of this invention is to allow Internet users (users) to lease their anonymous personal data (preferences) to web sites (publishers) in a way that is convenient, secure, and under user control. An embodiment of the invention accomplishes this objective via an interactive web application (the service) that provides users with a single central location to manage their preferences and relationships with publishers.

With regard to targeted advertising, the service can provide the publisher with targeting data that can extend to the keyword level, enabling more accurate targeting and thus higher ad revenues. In one embodiment of the invention, user-declared preference data can be matched to whatever segments that the publisher wishes to use to sell ad space. Segments may be comprised of categories, audience groupings, or keywords. This allows the publisher to take advantage of the better user data while retaining control over how ad space is sold. Users benefit from convenient access to multiple sites and services under a single login and a single source of preference data that they retain complete control over.

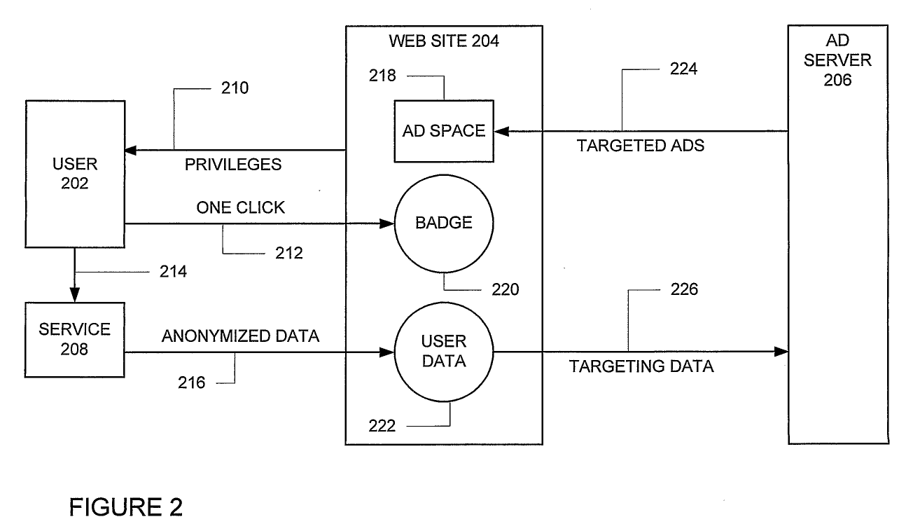

FIG. 2 illustrates how this process works. The site 204 places a badge 220 on the web page. The badge is a snippet of code supplied by the service 208. When a user 202 who is a member 214 of the service 208 sees the badge 220, one click 212 lets the user grant a Pass to the site 204, allowing the site to access the user's anonymous preference data 216 from the service 208 in return for privileges 210. In contrast with the user data 114 in the typical case, which is manually entered at each site, user data 222 supplied by the service 208 is based upon preferences managed centrally by the user, and is then processed to meet the particular needs of the publisher site 204 before transfer. One such way in which the data can be processed is to supply the site with targeting data 226, which is then used by an ad server 206 to select targeted ads 224 that are placed on the web page in an ad space 218 for viewing by the user. The ad server 206 may also be operated by either the site 204 or a third party.

In one embodiment of the invention, users enter preference data such as interest-related keywords and demographic data during signup or any other time at the service web site. In another embodiment of the invention, the service may also include client software such as browser plug-ins, extensions, or toolbars that help the user gather and store additional ongoing preference data such as visited web sites (browsing history), bookmarks, and any other information that might be useful to the user across various third party Internet applications, for example purchases made, tags used, and social contacts established. In one embodiment of the invention, preference data is by default stored by the service; in another embodiment of the invention, an option may also exist for the user to store the data with a third party or on a local computer.

In one embodiment of the invention, users can grant Passes to publishers, permitting anonymous access to specific preference data in return for premium and personalized content. The user retains access to a comprehensive list of all Passes granted, and can cancel any Pass at any time. If the user logs in to the system at a different time, potentially on another computer, all Pass data is reinstated and access to associated publisher content is restored.

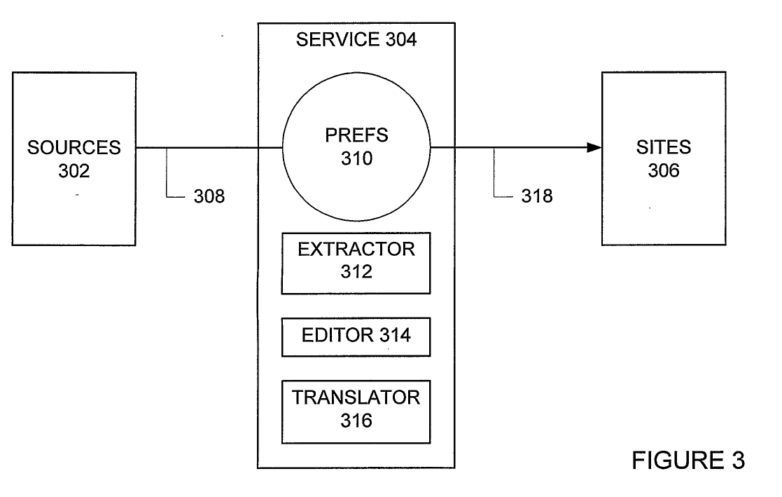

FIG. 3 illustrates how this process works in a particular embodiment of the invention. The user, in the course of using the service 304, supplies the service with Sources 302. Sources may be web sites that represent user interests, user profiles at community or social networking sites, or content that the user generates online. The service includes an extractor component 312 that extracts 308 preferences 310 from Sources 302. The service also provides users with an editor 314 so that at any time users can add, delete, or change their preferences, their Sources, or their Passes, which determine which sites 306 have permission to access their preferences. The service then uses a translator component 316 to translate user preferences into data that meets each site's specific needs, and then upon user permission transmit 318 this data to sites 306.

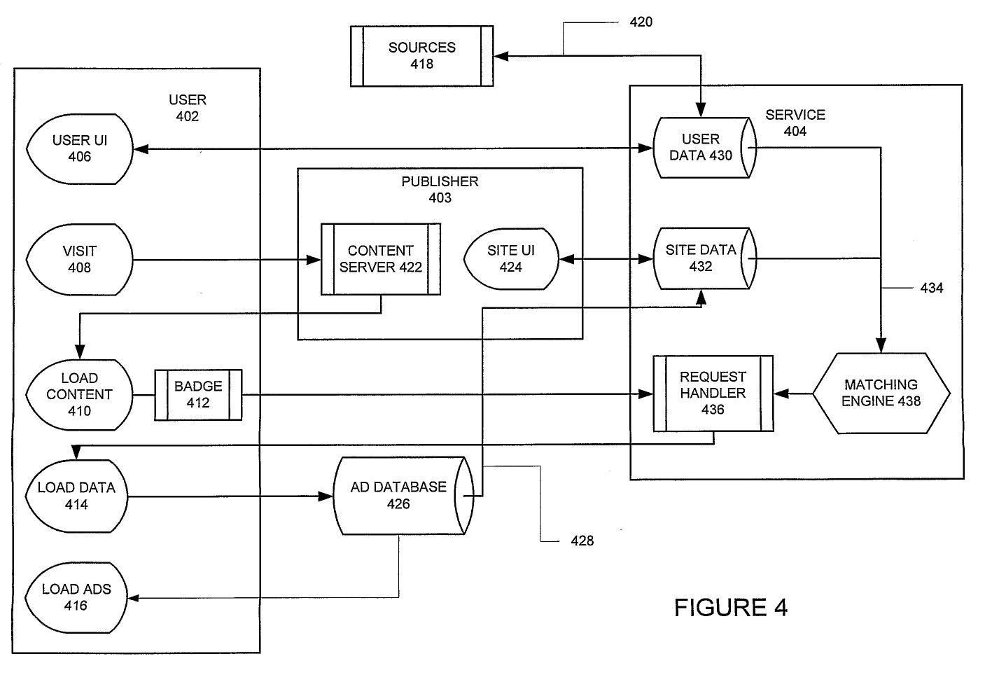

FIG. 4 depicts a typical interaction involving an example user and publisher in one embodiment of the invention. The user 402 enters data into the user database 430 via the web interface 406 provided by the service 404 (or for example via a toolbar or plug-in). Sources 418 named by the user may also update user preferences and vice versa 420, e.g. a social bookmarking site might update the user's tags as managed by the site when the user uses a new tag at the social bookmarking site. The publisher 403 has an account at the service 404 that is managed via a web interface 424. The publisher defines segments in the site database 432, possibly by extracting them 428 from the ad database 426. When the user 402 requests a web page 408 requiring a Pass from the publisher, the content server 422 sends the usual content page 410 with a section set aside and populated by the badge code 412 supplied by the service 404. This section asks the user for the appropriate action to grant a Pass, i.e. it asks the user to join the service, log in to the service, or grant a Pass to the publisher. Upon granting a Pass, the service request handler 436 transfers the user's preference data 414, customized by the matching engine 438 to the site's specific requirements based upon the user's preference data and the segments specified by the publisher 434. The page then uses this data to request ads 416 targeted using the matched segment data from the ad database 426.

In one embodiment of the invention, a Pass to a publisher is associated with a user level unique to that publisher. This user level is used to allow access to a certain portion of the publisher site by comparing it to a page level associated with each web page requested by the user. A key part of this is that in one embodiment of the invention, a content URL corresponding to the page originally requested by the user is passed along in the calls, so that the user can be redirected back to the content originally requested upon successful completion.

Both user preferences and publisher segments can, in one embodiment of the invention, be associated with arbitrary keywords, and the matching of one to the other therefore requires a measurement of closeness of meaning based upon semantic analysis. In one embodiment of the invention, the service computes this measure by utilizing tagging databases, a relatively new and growing class of Internet resources based upon third party services that use “tags,” or free-form keywords, as a basis for organizing data in an intuitive, bottom-up fashion (sometimes called a “folksonomy”). Examples include Google's gmail for email, del.icio.us and Furl for bookmarks, Flickr for photos, and the tagging or category function used in blogs and aggregated by Technorati. All of these applications share the core feature of enabling the user to assign at least one tag to at least one class of object. The aggregate assignment of multiple tags to an object can be used to conclude that these tags are semantically related, and extending this reasoning across objects can be used to generate a list of “related tags” for a given tag. These relationships can then be used to calculate a measure of semantic matching between two sets of arbitrary tags. In one embodiment of the invention, this is the method by which the service being described as part of this invention matches user preferences to publisher segments.

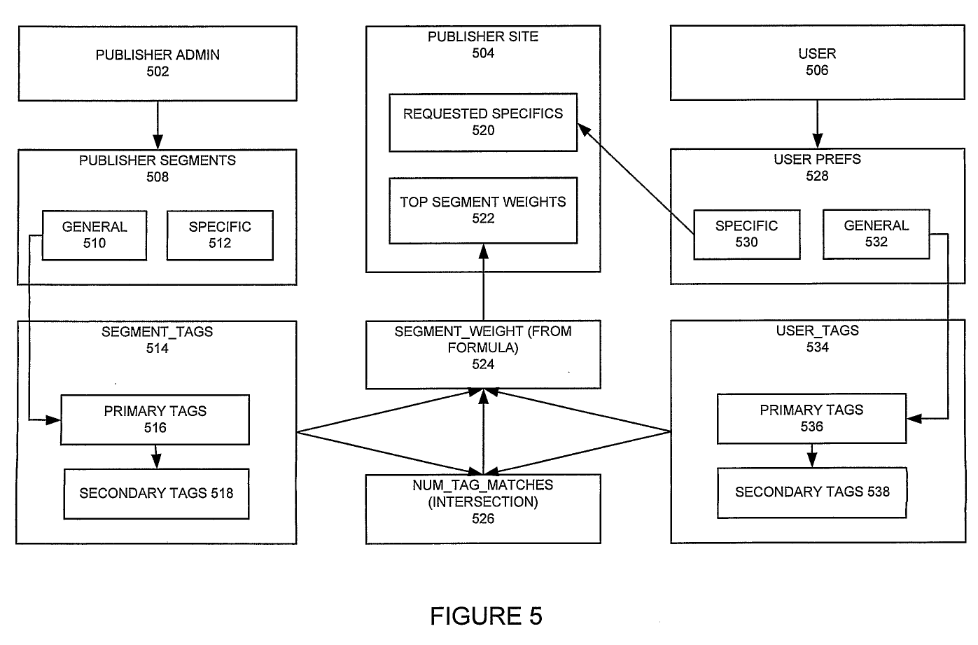

FIG. 5 shows the process by which the user's preferences can be matched to publisher segments in one particular embodiment of the invention. On the publisher side, an administrator 502 provides the service with publisher segments 508. General segments 510, for example categories, are to be matched to user preferences, while specific segments 512, for example demographics, are to be asked for directly. General segments 510 are then assigned primary tags 516, either by the publisher or by the service. These primary tags 516 are then used to generate secondary tags 518, for example by using a “related tags” function as described previously. The union of the primary tags 516 and the secondary tags 518 comprise the set SEGMENT_TAGS 514. On the user side 506, a similar procedure is used to generate the set USER_TAGS 534. The sets SEGMENT_TAGS 514 and USER_TAGS 534 can then be used to calculate a weight that measures the match between a given user and a given publisher segment.

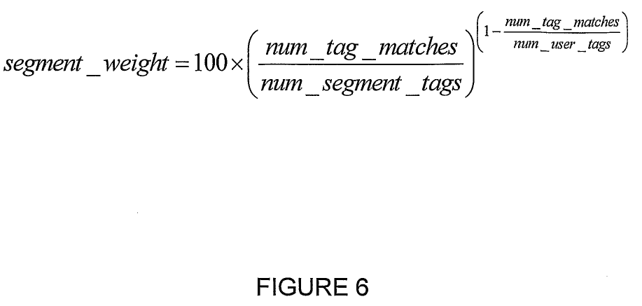

FIG. 6, considered in conjunction with FIG. 5, shows this weight can be calculated in one embodiment of the invention. The variables NUM_SEGMENT_TAGS and NUM_USER_TAGS are counts of the number of tags in the sets SEGMENT_TAGS 514 and USER_TAGS 534, while the variable NUM_TAG_MATCHES 526 comprises a count of the intersection of tags that reside in both the set SEGMENT_TAGS 514 and the set USER_TAGS 534. These variables can be used with the formula of FIG. 6 to calculate a SEGMENT_WEIGHT variable 524 that measures the match between a given user and a given publisher segment. The formula is designed to take the basic percentage match and amplify it by a root effect that grows with the percentage of the user's tags that matched. The segment weight will always be between 0 and 100. Here all user and segment tags are considered equally, whether originally provided or generated by the related tags service; in another embodiment of the invention, properties of primary tags could be used to assign weightings. Finally, for a given publisher site 504, the data transferred can comprise both the top weighted publisher segments 522 and whatever specific preferences 520 are requested.

In one embodiment of the invention, relevant user data, including matched segments, is accessed by the publisher via a subdomain cookie, i.e. a cookie stored in the user's browser that is associated with a subdomain such as service.publisher.com. This subdomain is routed to computers associated with the service via DNS assignments made by the publisher. The cookie associated with this subdomain is therefore writable and readable by the service's computers, while also being readable by the publisher's computers that supply content and advertisements. When the user logs in to the service, all such subdomain cookies are rewritten to the browser, and when the user logs out of the service, all such subdomain cookies are deleted.

In another embodiment of the invention, relevant user data, including matched segments, is accessed by the publisher via scripting variables, for example javascript variables, set as part of the badge code or a separate snippet of code. The data in these variables can then be passed back to the publisher's servers or placed in a publisher cookie using additional scripting code on the web page. Sites may also be able to access user data by means other than a subdomain cookie or scripting variables, such as a REST API or an RSS feed.

An aspect of the present invention in one embodiment is that in addition to preference data, a unidirectional ID is transferred to the site for use in recognizing the user across different sessions and computers. The unidirectional ID is unique to each user/site pairing, and therefore is not vulnerable to correlation. This ID may also be used by the site to access user data, for example using an RSS feed whose path includes the ID. A notable part of this is that in one embodiment of the invention, an anonymous email address managed by the service can be provided to a publisher as part of a Pass. Only emails from domains associated with publishers granted Passes will be accepted by this email address, and if the Pass is cancelled for a given publishers, emails will no longer be accepted from domains associated with that publisher. Another notable capability is that in another embodiment of the invention, an entire social network, i.e. a list of friends identified by service IDs, may be accessed by a publisher as part of a Pass; no email confirmation or interaction is then required of such friends, they will be automatically connected within the social network managed by that publisher only if the friend also grants the publisher a Pass.

Another aspect present in one embodiment of the invention is that other publishers offering functionalities such as search, recommendations, and social networking can also ask for user data to personalize their sites and make signup more convenient. This leads to higher signup rates and better functionality for the publisher, while users again benefit from convenient access and control over their data. Such non-advertising related uses of preference data motivate the user to provide data that is accurate and up-to-date, since it is used for purposes that the user might value more than relevant advertisements. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system that enables a user to form a relationship with a web site, comprising:
means for transferring an anonymous profile that is customized to a visited web site; and
means for forming a persistent anonymous relationship with the visited web site without requiring a username and password for that visited web site, wherein the means for forming this relationship comprise one click, including the transfer of anonymous preference data.

2. The system of claim 1 wherein the web site owner inserts a single snippet of code in order to enable the one click relationship capability for users.

3. The system of claim 1 wherein the user is uniquely identified by the website without the website being able to associate the user with a global identity or identifier.

4. The system of claim 1 wherein the web site can specify both the method and the form in which user preference data is transferred.

5. The system of claim 1 wherein user preference data are translated into the form requested by the site, optimized for use in ad targeting.

6. A method comprising:
providing a matching process that builds primary and secondary tags anonymously from general user preferences and publisher segments; and
providing a formula for using the primary and secondary tags to generate a weight that measures the match between a given user's preferences and a given publisher segment.
